(19) United States
(12) Patent Application Publication
(10) Pub. No.: US 2006/0123397 A1
(43) Pub. Date: Jun. 8, 2006

(54) Apparatus and method for optimization of virtual machine operation

(76) Inventor: James B. McGuire, Delray Beach, FL (US)

Correspondence Address: MOTOROLA INC, 600 NORTH US HIGHWAY 45, ROOM AS437, LIBERTYVILLE, IL, 60048-5343, US

(21) Appl. No.: 11/007,452

(22) Filed: Dec. 8, 2004

(51) Int. Cl. G06F 9/44

(52) U.S. Cl. 717/127

(57) ABSTRACT

An apparatus and method of optimization of virtual machine operation. The performance of program code can be monitored during program execution. At least one program code region can be determined as a hot execution spot. During program execution, the at least one program code region can be loaded into a storage media that is more effective for hot execution spot execution than another storage media present on a device.

### BACKGROUND

1. Field

The present disclosure is directed to a method and apparatus for optimization of virtual machine operation. More particularly, the present disclosure is directed to optimizing virtual machine hot spot operation.

2. Description of Related Art

Presently, virtual machine programming languages, such as the Java programming language and environment, are designed to solve a number of problems in modern programming practice. For example, Java is designed to meet the challenges of application development in the context of heterogeneous, network-wide distributed environments. Among these challenges, it is important to provide secure delivery of applications that consume the minimum of system resources, can run on any hardware and software platform, and can be extended dynamically. Java is a simple, object-oriented, network-savvy, interpreted, robust, secure, architecture neutral, portable, multithreaded, dynamic language.

A Java program is created by compiling source code written in Java Language's format into a compact, architecture-neutral object code known as Java byte code. Compilation normally consists of translating Java source code into a machine independent Java byte code representation. Java byte codes are translated, i.e., interpreted, on the fly into native machine code for the particular processor the application is running on. Byte codes are executed at runtime by an interpreter residing on the client computer. Runtime activities may include loading and linking the classes needed to execute a program, machine code generation and dynamic optimization of the program, and actual program execution.

A program written in the Java Language compiles to a byte code file that can run wherever a Java Platform is present. This portability is possible because at the core of a Java Platform is a Java Virtual Machine. Java byte codes are designed to operate on a Java Virtual Machine (VM). The Java Virtual Machine is an abstract computing machine that has its own instruction set. A Java VM is not necessarily an actual hardware platform, but rather a low level software emulator that can be implemented on many different processor architectures and under many different operating systems. A Java VM reads and interprets each byte code so that the instructions may be executed by the native microprocessor. Hence compiled Java byte codes are capable of functioning on any platform that has a Java Virtual Machine implementation available.

However, byte code interpretation detracts from program performance since the microprocessor has to spend part of its processing time interpreting byte codes. Java “Just In Time” (JIT) compilers were introduced to improve the performance of Java Virtual Machines. A Java JIT compiler translates Java byte codes into the processor's native machine code during runtime. The processor then executes the compiled native code like any other native program. Such compiled Java programs execute much faster than Java programs that are executed using a Java interpreter.

Although a Just In Time compiled Java program executes faster than an interpreted Java program, the performance of such Just In Time compiled Java programs can be further improved. In order to harness performance improvements from Java code via JIT compilation, a program's Java byte codes have to be JIT complied. Since Just In Time compilations are performed during program runtime, the compile time adds to the time constraint during execution time. Furthermore, since the native machine code outputted by a JIT compiler is not saved, the program's Java byte codes have to be JIT compiled every time the program is loaded and run. JIT compilers also do not produce efficient code since they must quickly produce the code and thus the code is not optimized.

Unfortunately, a JIT complier is still code intensive, requiring extensive memory and processing power for running the compiler. This memory and processing power is not always available on small portable devices. For example, because a compiler runs on an execution machine in real time, it is severely constrained in terms of compile speed. In particular, if the compiler is not very fast, then the user will perceive a significant delay in the startup of a program or a part of a program. This can result in a trade-off that makes it far more difficult to perform advanced optimizations, which usually slow down compilation performance significantly. Additionally, even if a JIT compiler had enough time to perform full optimization, such optimizations are less effective for the Java programming language than traditional languages.

Thus, there is a need for an improved apparatus and method of optimization of virtual machine operation.

### SUMMARY

The disclosure provides an improved apparatus and method of optimization of virtual machine operation. The performance of program code can be monitored during program execution. At least one program code region can be determined as a hot execution spot. The at least one the program code region, during program execution, can be loaded into a storage media that is more effective for hot execution spot execution than another storage media present on a device.

### BRIEF DESCRIPTION OF THE DRAWINGS

The embodiments of the present disclosure will be described with reference to the following figures, wherein like numerals designate like elements, and wherein:

FIG. 1 is an exemplary block diagram of a device according to one embodiment;

FIG. 2 is an exemplary block diagram of a controller according one embodiment;

FIG. 3 is an exemplary flowchart illustrating the operation of the device according to another embodiment; and

FIG. 4 is an exemplary flowchart illustrating the operation of the device according to another embodiment.

### DETAILED DESCRIPTION

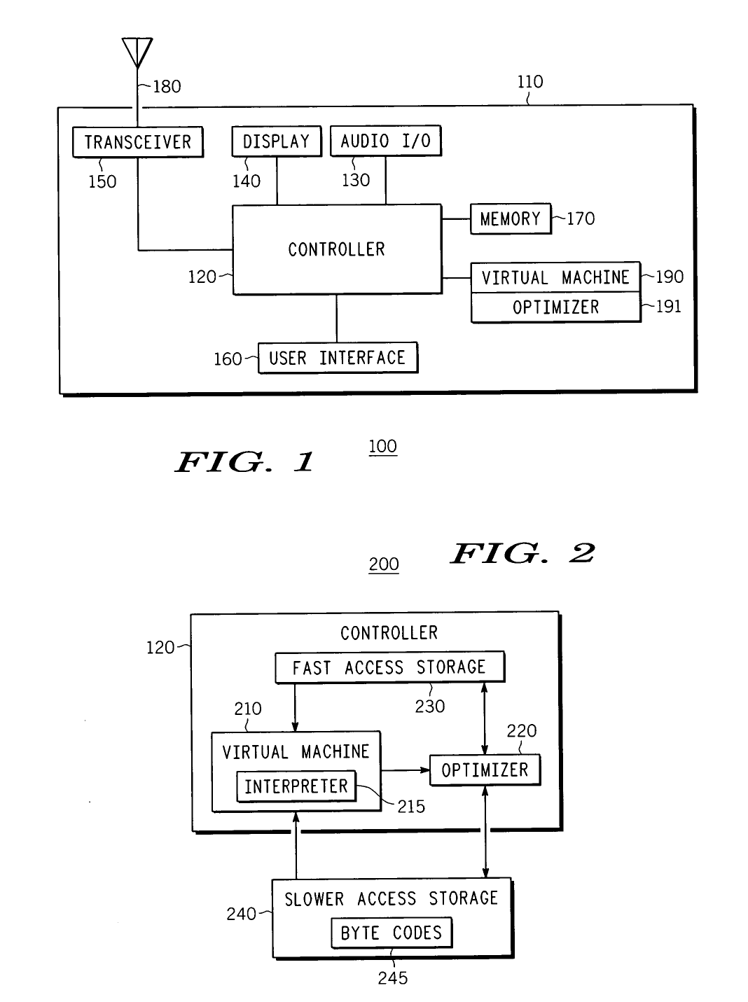

FIG. 1 is an exemplary block diagram of a device 100, according to one embodiment. The device 100 can include a housing 110, a controller 120 coupled to the housing 110, audio input and output circuitry 130 coupled to the housing 110, a display 140 coupled to the housing 110, a transceiver 150 coupled to the housing 110, a user interface 160 coupled to the housing 110, a memory 170 coupled to the housing 110, and an antenna 180 coupled to the housing 110 and the transceiver 150. The device 100 can also include a virtual machine 190 and an optimizer 191. The virtual machine 190 and the optimizer 191 can be coupled to the controller 120, can reside within the controller 120, can reside within the memory 170, can be autonomous modules, can be software, can be hardware, or can be in any other format useful for a module on a device 100.

The display 140 can be a liquid crystal display (LCD), a light emitting diode (LED) display, a plasma display, or any other means for displaying information. The transceiver 150 may include a transmitter and/or a receiver. The audio input and. output circuitry 130 can include a microphone, a speaker, a transducer, or any other audio input and output circuitry. The user interface 160 can include a keypad, buttons, a touch pad, a joystick, an additional display, or any other device useful for providing an interface between a user and a electronic device. The memory 170 may include a random access memory, a read only memory, an optical memory, a subscriber identity module memory, or any other memory that can be coupled to a mobile communication device.

The device 100 may be a telephone, a wireless telephone, a cellular telephone, a personal digital assistant, a pager, a personal computer, a mobile communication device, a selective call receiver or any other device that is capable of implementing a virtual machine. The device 100 may send and receive signals on a network. Such a network can include any type of network that is capable of sending and receiving signals, such as wireless signals. For example, the network may include a wireless telecommunications network, a cellular telephone network, a satellite communications network, and other like communications systems. Furthermore, the network may include more than one network and may include a plurality of different types of networks. Thus, the network may include a plurality of data networks, a plurality of telecommunications networks, a combination of data and telecommunications networks and other like communication systems capable of sending and receiving communication signals.

The device 100 may include a first storage media and a second storage media. The first storage media and the second storage media can be located in the memory 170, on the controller 120, or elsewhere in the device 100. The second storage media can be more effective for hot execution spot execution than the first storage media. For example, the second storage media can have a faster access speed, than the first storage media. For example, the device 100 can include Flash media for storage and random access memory (RAM) for variables. The Flash media may be removable memory. Also, the RAM may be divided into two types: internal and external to the controller 120 or to a processor on the controller 120. An internal RAM on a processor may have no wait states and can thus be more efficient than Flash media or an external RAM. The external RAM may also be more efficient than Flash media.

In operation, the virtual machine 190 can include a byte code interpreter for executing program code. The optimizer 191 can be a virtual machine optimizer 191. The virtual machine optimizer 191 can monitor performance of program code during program execution, determine at least one program code region is a hot execution spot, and load the at least one the program code region, during program execution, into the second storage media that is more effective for hot execution spot execution than the first storage media. The controller 120 can store the program code in the first storage media and the virtual machine optimizer 191 can then load only the at least one program code region determined to be a hot execution spot into the second storage media that is more effective for hot execution spot execution than the first storage media during program execution. The at least one program code region loaded into the second storage media that is more effective for hot execution spot execution can be byte-codes of the program code region. The virtual machine optimizer 191 can also ascertain the at least one program code region is no longer a hot execution spot and remove the at least one program code region from the second storage media. The virtual machine optimizer 191 can additionally select at least one other program code region as another hot execution spot and load the at least one other program code region into the second storage media. The second storage media that is more effective for hot execution spot execution can be a high speed random access memory. The second storage media that is more effective for hot execution spot execution can be an internal random access memory embedded on the device 100. The first storage media can be an on-board random access memory, a removable storage media, or any other memory or media that is less effective for program execution than the second storage media. The virtual machine optimizer 191 can further determine an application requires the use of the second storage media that is more effective for hot execution spot execution and remove the at least one program code region from the second storage media. The virtual machine optimizer 191 can also determine at least one program code region is a hot execution spot based on the at least one program code region being more executed than other program code regions.

Thus, the optimizer 191 can determine if a program is spending the vast majority of its time executing a small minority of its code. The optimizer 191 can detect this small minority of code and designate the code as a hot spot. The optimizer 191 can then load this hot spot into storage media that is the most effective for byte code execution, such as a high speed RAM or an on-chip RAM. When the byte code is no longer the hot spot, the optimizer 191 can remove the byte code from the storage media that is the most effective for byte code execution. Thus, the fetch cycle of a virtual machine can be greatly reduced and byte code applications can run faster. Also, the internal RAM of embedded devices can be optimized because the internal RAM is only used when needed and is dynamically freed for other applications to use.

FIG. 2 is an exemplary block diagram 200 of the controller 120 according to another related embodiment. The controller 120 can include a virtual machine 210 having an interpreter 215, a virtual machine monitoring optimizer 220, and a fast access storage 230. The controller 120 can also utilize a slower access storage 240.

In operation, byte codes 245 are loaded into the slower access storage 240, such as flash memory of the device 100, for execution by the virtual machine 210. The interpreter 215 of the virtual machine 210 can execute the byte codes out of the slower access storage 240. The virtual machine 210 can report a current execution path to the monitoring optimizer 220. The monitoring optimizer 220 can determine the most executed byte code path and can load the most executed byte code path into the fast access storage 230 such as a fast access memory. The monitoring optimizer 220 can then notify the interpreter 215 to begin loading the most executed byte code from the fast access storage 230 instead of the slower access storage 240. The monitoring optimizer 220 can continue to monitor the execution of the virtual machine 210. As the virtual machine 210 runs, the program execution load may shift and can cause the monitoring optimizer 220 to add or remove code from the fast access storage 230 as the code becomes more often or less often executed, respectively.

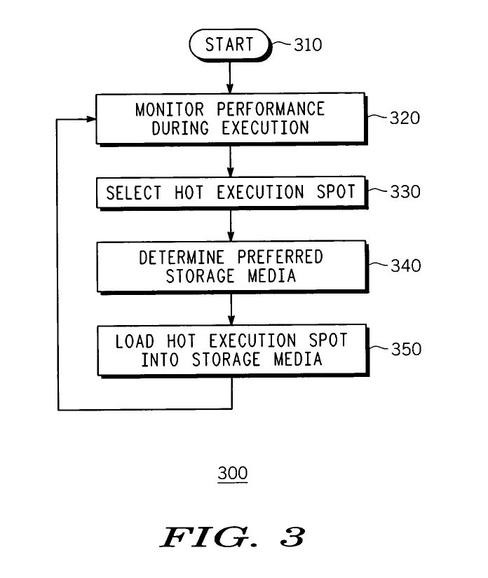

FIG. 3 is an exemplary flowchart 300 illustrating the operation of the device 100 according to another embodiment. In step 310, the flowchart begins. In step 320, the device 100 can monitor performance of program code during program execution. In step 330, the device 100 can select at least one program code region as a hot execution spot. In step 340, the device 100 can determine a storage media that is most effective for hot execution spot execution. In step 350, the device 100 can load the program code region into the storage media that is most effective for hot execution spot execution. The device 100 can then continue to monitor performance in step 320. The device 100 can perform all of these steps while the program code is being executed. The storage media that is most effective for hot execution spot execution can be a high speed random access memory, an internal random access memory embedded on the device, or any other storage media that is more effective for hot execution spot execution than another storage media on the device 100. The device 100, while monitoring performance in step 320, can store program code regions that are not hot execution spots in storage media that is less effective for hot execution spot execution. The program code region loaded into the storage media that is most effective for hot execution spot execution can be byte-codes of the program code region. The at least one program code region can be a byte code path. The device 100 can select at least one program code region a hot execution spot by determining a byte code path is more executed than other byte code paths and selecting the at least one program code region a hot execution spot based on the byte code path being more executed than other byte code paths.

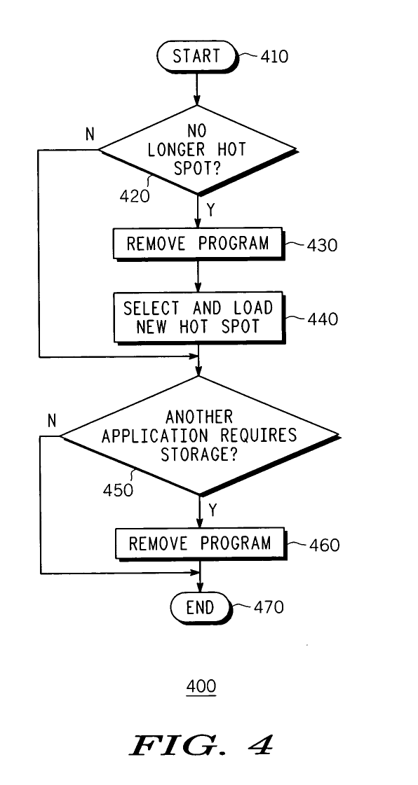

FIG. 4 is an exemplary flowchart 400 illustrating the operation of the device 100 according to another related embodiment. The flowchart 400 can be used concurrently with or in addition to the flowchart 300. In step 410, the flowchart begins. In step 420, the device 100 can ascertain the at least one program code region is no longer a hot execution spot. If the at least one program code region is no longer a hot execution spot, in step 430, the device 100 can remove the at least one program code region from the storage media that is most effective for hot execution spot execution. In step 440, the device 100 can select at least one other program code region as another hot execution spot and load the at least one other program code region into the storage media that is most effective for hot execution spot execution. In step 450, the device 100 can determine an application requires the use of the storage media that is most effective for hot execution spot execution. If an application requires the use of the storage media that is most effective for hot execution spot execution, in step 460, the device 100 can remove the program code region from the storage media that is most effective for hot execution spot execution. In step 470, the flowchart can end.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

What is claimed is:

1. A method on a device comprising:
monitoring performance of program code during program execution;
selecting at least one program code region as a hot execution spot;
determining a storage media that is most effective for hot execution spot execution; and
loading the program code region, during program execution, into the storage media that is most effective for hot execution spot execution.

2. The method according to claim 1, further comprising:
ascertaining the at least one program code region is no longer a hot execution spot; and
removing the at least one program code region from the storage media that is most effective for hot execution spot execution.

3. The method according to claim 2, further comprising selecting at least one other program code region as another hot execution spot; and
loading the at least one other program code region into the storage media that is most effective for hot execution spot execution.

4. The method according to claim 1, wherein the storage media that is most effective for hot execution spot execution comprises a high speed random access memory.

5. The method according to claim 1, wherein the storage media that is most effective for hot execution spot execution comprises an internal random access memory embedded on the device.

6. The method according to claim 1, further comprising:
determining an application requires the use of the storage media that is most effective for hot execution spot execution; and
removing the program code region from the storage media that is most effective for hot execution spot execution.

7. The method according to claim 1, further comprising storing program code regions that are not hot execution spots in storage media that is less effective for hot execution spot execution.

8. The method according to claim 1, wherein the program code region loaded into the storage media that is most effective for hot execution spot execution comprises byte-codes of the program code region.

9. The method according to claim 1, wherein the at least one program code region comprises a byte code path, and
wherein selecting at least one program code region a hot execution spot further comprises determining a byte code path is more executed than other byte code paths and selecting the at least one program code region as a hot execution spot based on the byte code path being more executed than other byte code paths.

10. An apparatus comprising:
a first storage media;
a second storage media, the second storage media being more effective for hot execution spot execution than the first storage media;
a controller coupled to the first storage media and the second storage media, the controller including:
a virtual machine having a byte code interpreter for execute program code; and
a virtual machine optimizer, the virtual machine optimizer configured to monitor performance of program code during program execution, determine at least one program code region is a hot execution spot, and load the at least one program code region, during program execution, into the second storage media that is more effective for hot execution spot execution than the first storage media.

11. The apparatus according to claim 10, wherein the controller stores the program code in the first storage media and wherein the virtual machine optimizer loads only the at least one program code region determined to be a hot execution spot, during program execution, into the second storage media that is more effective for hot execution spot execution than the first storage media.

12. The apparatus according to claim 10, wherein the at least one program code region loaded into the storage media that is more effective for hot execution spot execution comprises byte-codes of the program code region.

13. The apparatus according to claim 10, wherein the virtual machine optimizer is further configured to ascertain the at least one program code region is no longer a hot execution spot and remove the at least one program code region from the second storage media.

14. The apparatus according to claim 13, wherein the virtual machine optimizer is further configured to select at least one other program code region as another hot execution spot and load the at least one other program code region into the second storage media.

15. The apparatus according to claim 10, wherein the second storage media that is more effective for hot execution spot execution comprises a high speed random access memory.

16. The apparatus according to claim 10, wherein the second storage media that is more effective for hot execution spot execution comprises an internal random access memory embedded on the device.

17. The apparatus according to claim 10, wherein the first storage media comprises at least one of an on-board random access memory and a removable storage media.

18. The apparatus according to claim 10, wherein the virtual machine optimizer is further configured to determine an application requires the use of the second storage media that is more effective for hot execution spot execution and remove the at least one program code region from the second storage media.

19. The apparatus according to claim 10, wherein the virtual machine optimizer determines at least one program code region is a hot execution spot based on the at least one program code region being more executed than other program code regions.

20. A selective call receiver comprising:
a display;
a numeric keypad;
a transceiver;
a first storage media;
a second storage media, the second storage media being more effective for hot execution spot execution than the first storage media;
a controller coupled to the display, the numeric keypad, the transceiver, the first storage media and the second storage media, the controller including:
a virtual machine having a byte code interpreter for execute program code; and
a virtual machine optimizer, the virtual machine optimizer configured to monitor performance of program code during program execution, determine at least one program code region is a hot execution spot, and load at least one the program code region, during program execution, into the second storage media that is more effective for hot execution spot execution than the first storage media.
